(19) United States
(12) Patent Application Publication
(10) Pub. No.: US 2015/0120076 A1
(43) Pub. Date: Apr. 30, 2015

(54) ELECTRONIC DEVICE HAVING INTELLIGENT TEMPERATURE ADJUSTING FUNCTION

(71) Applicants: HON HAI PRECISION INDUSTRY CO., LTD., New Taipei (TW); Fu Tai Hua Industry (Shenzhen) Co., Ltd., Shenzhen (CN)

(72) Inventor: CHUAN WANG, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/254,056

(22) Filed: Apr. 16, 2014

(30) Foreign Application Priority Data
Oct. 31, 2013 (CN) 2013105266488

(51) Int. Cl. G05F 1/66; G05D 23/19

(52) U.S. Cl. CPC G05F 1/66; G05D 23/19
USPC 700/297

(57) ABSTRACT

An electronic device includes a storage unit storing a predefined temperature value range, a heat generating element, a processor, and a temperature adjustment module. The temperature adjustment module includes a temperature sensor for detecting the temperature of the heat generating element, a power generating module, and a temperature adjustment board. A surface of the power generating module is affixed on the heat generating element for utilizing the temperature difference to generate electricity. The processor includes a power generating control and a heating control module. The power generating controls the power generating module to generate electricity when the temperature value of the heat generating element is higher than the upper limit of the predefined temperature value range. The heating control module controls the temperature adjustment board to heat when the temperature value of the heat generating element is lower than the lower limit of the predefined temperature value range.

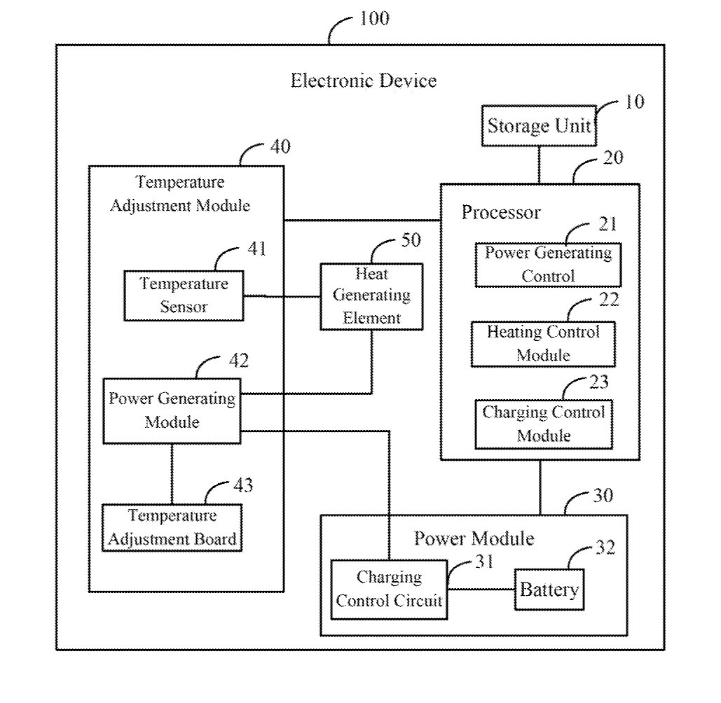

### FIELD

The present disclosure relates to an electronic device having an intelligent temperature adjusting function.

### BACKGROUND

Portable electronic devices such as mobile phones, tablet computers, personal digital assistants are popular due to the various powerful functions and large screen size. However, the heat of the processor of the portable electronic device increases with the increasing time period of use and quantity of running applications. Conventionally, the heat from the processor is transmitted to the housing of the electronic device, thus, the user feels the heat directly from the housing when holding the electronic device, which may be hot and uncomfortable. When the electronic device works in an environment having a relatively low temperature, the user may feel cold when holding the electronic device even the electronic device generates heat itself.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding sections throughout the several views.

The FIGURE is a block diagram of an electronic device in accordance with an exemplary embodiment.

### DETAILED DESCRIPTION

The FIGURE illustrates an exemplary embodiment of a disclosure of an electronic device 100. In the embodiment, the electronic device 100 automatically adjusts the temperature of itself to control the temperature to be within a predefined value range. The electronic device 100 is a tablet computer. In alternative embodiments, the electronic device 100 can be other electronic devices, such as an electronic reader, a digital phone frame, a mobile phone, or a personal digital assistant, for example.

The electronic device 100 includes a storage unit 10, a processor 20, a power module 30, a temperature adjustment module 40, and a heat generating element 50. The storage unit 10 stores a predefined temperature value range, such as a temperature range from 27 degrees Celsius to 35 degrees Celsius. The predefined temperature value range includes an upper limit (such as 35 degrees Celsius) and a lower limit (27 degrees Celsius), which can be predefined by a user or a default set of the system of the electronic device 100. In at least one embodiment, the heat generating element 50 is an element of the electronic device 100 which emits a lot of heat. In an embodiment, the heat generating element 50 is the processor 20, or a backlight unit, for example.

The temperature adjustment module 40 includes a temperature sensor 41, a power generating module 42, and a temperature adjustment board 43. The temperature sensor 41 is arranged on the heat generating element 50 to detect a temperature of the heat generating element 50, convert the detected temperature to temperature data and transmit the converted temperature data to the processor 20. In at least one embodiment, the temperature sensor 41 real-timely detects the temperature of the heat generating element 50. In an alternative embodiment, the temperature sensor 41 detects the temperature of the heat generating element 50 every a predefined time period.

Two surfaces of the power generating module 42 are affixed on the heat generating element 50 and the temperature adjustment board 43 respectively, for utilizing the temperature difference between the two surfaces to generate electricity under the control of the processor 20. Thus, the power generating module 42 absorbs the thermal energy of the heat generating element 50 to radiating the heat from the heat generating element 50. The temperature board 43 is configured to heat or stop heating in under the control of the processor 20, thus heating or stop heating the electronic device 100.

The power module 30 includes a charging control circuit 31 and a battery 32. The charging control circuit 31 is connected between the power generating module 42 and the battery 32, and is configured to convert the voltage of the electricity generated by the power generating module 42 to a proper voltage for charging the battery 32 under the control of the processor 20.

The processor 20 includes a power generating control 21, a heating control module 22, and a charging control module 23. The power generating control 21 is configured to control the power generating module 42 to work or stop working according to the temperature data of the heat generating element 50 transmitted from the temperature sensor 41. In at least one embodiment, the power generating control 21 controls the power generating module 42 to generate electricity when the power generating control 21 determines that the temperature value of the heat generating element 50 is higher than the upper limit of the predefined temperature value range according to the temperature data of the heat generating element 50. The power generating control 21 controls the power generating module 42 to stop generating electricity when the power generating control 21 determines that the temperature value of the heat generating element 50 is lower than the lower limit of the predefined temperature value range according to the temperature data of the heat generating element 50.

The heating control module 22 is configured to control the temperature adjustment board 43 to work or stop working according to the temperature data of the heat generating element 50 transmitted from the temperature sensor 41. In the embodiment, the heating control module 22 controls the temperature adjustment board 43 to heat when the heating control module 22 determines that the temperature value of the heat generating element 50 is lower than the lower limit of the predefined temperature value range, thus heating the electronic device. Otherwise, the heating control module 22 controls the temperature adjustment board 43 to stop heating.

When the power generating module 42 is working, the charging control module 23 controls the charging control circuit 31 to convert the voltage of the electricity generated by the power generating module 42 to a proper voltage, and to charge to the battery 32. In at least one embodiment, the charging control module 23 determines whether the power generating module 42 is working according to the control under the power generating control 21 for the power generating module 42.

With such a configuration as described, when the detected temperature value of the heat generating element 50 is beyond the predefined temperature value range stored in the storage unit 10, the electronic device 100 controls the power generating module 42 or the temperature adjustment board 43 to work accordingly. Thus to radiate or heat the electronic device 100 and the heat generating element 50 accordingly. Compared to the conventional electronic device using the housing to radiate, the temperature value of the electronic device 100 and the heat generating element 50 is adjusted to be within the predefined temperature value range, which can make the electronic device 100 more comfortable to hold. Additionally, the electricity generated by the power generating module 42 using the heat is saved in the battery 32, lowering the power consumption of the electronic device 100 and extending battery life between charging periods.

Although the present disclosure has been specifically described on the basis of the embodiments thereof, the disclosure is not to be construed as being limited thereto. Various changes or modifications may be made to the embodiments without departing from the scope of the disclosure.

What is claimed is:

1. An electronic device comprising:
a storage unit storing a predefined temperature value range;
a heat generating element;
a temperature adjustment module, comprising:
a temperature sensor arranged on the heat generating element, configured to detect a temperature of the heat generating element and convert the detected temperature to temperature data;
a power generating module, a surface of which being affixed on the heat generating element for utilizing the temperature difference to generate electricity; and
a temperature adjustment board; and
a processor, comprising:
a power generating control, configured to control the power generating module to generate electricity when the power generating control determines that a temperature value of the heat generating element is higher than an upper limit of the predefined temperature value range according to the converted temperature data; and
a heating control module, configured to control the temperature adjustment board to heat when the heating control module determines that a temperature value of the heat generating element is lower than a lower limit of the predefined temperature value range according to the converted temperature data.

2. The electronic device as described in claim 1, wherein the power generating control controls the power generating module to stop generating electricity when the temperature value of the heat generating element is lower than the upper limit of the predefined temperature value range.

3. The electronic device as described in claim 1, wherein the heating control module controls the temperature adjustment board to stop heating when the temperature value of the heat generating element is higher than the lower limit of the predefined temperature value range.

4. The electronic device as described in claim 1, further comprising:
a battery; and
a charging control circuit, connected between the power generating module and the battery.

5. The electronic device as described in claim 4, wherein the processor further comprises a charging control module configured to control the charging control circuit to convert a voltage of the electricity generated by the power generating module to a proper voltage, and to charging to the battery.

6. The electronic device as described in claim 1, wherein the electronic device is at least one of a tablet computer and a mobile phone.

7. An electronic device comprising:
a storage unit storing a predefined temperature value range;
a temperature adjustment module, comprising:
a temperature sensor arranged on the processor, configured to detect a temperature of the processor and convert the detected temperature to temperature data;
a power generating module, a surface of which being affixed on the processor for utilizing the temperature difference to generate electricity; and
a temperature adjustment board; and
a processor, comprising:
a power generating control, configured to control the power generating module to generate electricity when the power generating control determines that a temperature value of the processor is higher than an upper limit of the predefined temperature value range according to the converted temperature data; and
a heating control module, configured to control the temperature adjustment board to heat when the heating control module determines that a temperature value of the processor is lower than a lower limit of the predefined temperature value range according to the converted temperature data.

8. The electronic device as described in claim 7, wherein the power generating control controls the power generating module to stop generating electricity when the temperature value of the processor is lower than the upper limit of the predefined temperature value range.

9. The electronic device as described in claim 7, wherein the heating control module controls the temperature adjustment board to stop heating when the temperature value of the processor is higher than the lower limit of the predefined temperature value range.

10. The electronic device as described in claim 7, further comprising:
a battery; and
a charging control circuit, connected between the power generating module and the battery.

11. The electronic device as described in claim 10, wherein the processor further comprises a charging control module configured to control the charging control circuit to convert a voltage of the electricity generated by the power generating module to a proper voltage, and to charging to the battery.

12. The electronic device as described in claim 7, being a tablet computer or a mobile phone.
